(19) United States
(12) Patent Application Publication
(10) Pub. No.: US 2019/0382219 A1
(43) Pub. Date: Dec. 19, 2019

(54) Device for storing and transporting large-volume foam blocks

(71) Applicant: Albrecht Bäumer GmbH & Co. KG Spezialmaschinenfabrik, Freudenberg (DE)

(72) Inventor: Christoph Moisel, Cologne (DE)

(73) Assignee: Albrecht Bäumer GmbH & Co. KG Spezialmaschinenfabrik, Freudenberg (DE)

(21) Appl. No.: 16/438,426

(22) Filed: Jun. 11, 2019

(30) Foreign Application Priority Data
Jun. 13, 2018 (DE) 10 2018 209 421.7

(51) Int. Cl. B65G 57/03; B65B 5/06; B65B 43/52

(52) U.S. Cl. CPC B65G 57/03; B65G 2201/025; B65B 43/52; B65B 5/06

(57) ABSTRACT

A device for storing and transporting large-volume foam blocks includes a mobile, stackable storage box for receiving a foam block at a loading position and a transport device for transporting the storage box from the loading position to a floor storage. The device is suitable to store and transport large-volume, soft, viscoelastic foam blocks in a safe, simple, inexpensive and space-saving manner.

### TECHNICAL FIELD

The disclosure relates to a device for storing and transporting large-volume foam blocks, in particular to curing racks with a conveying device.

### BACKGROUND

Very soft, viscoelastic foams and freshly produced foam blocks, which have not completely hardened after the foaming process and which, due to the remaining heat of reaction, must still cure and cool down, are nowadays stored as large-volume foam blocks in rack storages. These racks are filled with the help of a stacker crane via the longitudinal axis. Such storage warehouses are described for example in a Wikipedia article at https://de.wikipedia.org/wiki/Langgutlager in the version of Jan. 22, 2018.

Block or honeycomb storage systems are storage systems in which the material is arranged in bins, i.e. open, elongated containers, in a honeycomb-like shelf block next to each other. Access to the stored material is provided by a stacker crane as a conveying device which is horizontally, vertically and also diagonally movable in front of the honeycomb storage system. The possible diagonal movement in front of the shelf block of the honeycomb storage system and the immediate access to each bin results in a high storage and retrieval performance.

The front of such honeycomb storage systems looks like a checkerboard. In the block or honeycomb storage systems, the individual shelf trays are equipped with driven conveyor belts. Typical dimensions of the blocks to be stored are approximately between 2 m and 120 m in length, up to 2.5 m in width, and up to a height of 1.5 m.

Disadvantages of the system are the large space that is required exclusively for the stacker crane, the many drives in each of the shelf trays, and the belts in need of maintenance, as well as a high variety of variants, especially in stacker cranes. This also results in a high configuration effort for the systems, since these must each be adapted to the specific dimensional wishes of the customers and in particular to basic spatial requirements.

### SUMMARY

The disclosure is based on the object to improve known curing racks in such a way that the disadvantages of the prior art are avoided. The improved system guarantees a safe, simple, inexpensive and space-saving way to store and transport large-volume, soft, viscoelastic foam blocks, without damaging the freshly produced foam blocks, which are not fully cured after foaming.

The object is achieved by providing at least one mobile storage box for receiving at least one foam block at a loading position, and a transport device for transporting the storage box from the loading position into at least one floor storage.

By providing a dedicated loading position, the elaborate and space-consuming stacker crane used in prior art solution is no longer required. Instead, the mobile storage boxes can be transported inexpensively via usually existing gantry, ceiling or mobile container cranes or for example via forklifts.

At the loading position the device preferably comprises a feed conveyor and a loading device onto which at least one mobile, stackable storage box can be placed. Foam blocks can be introduced by the feed conveyor and the loading device into the storage boxes. After the introduction of the foam blocks, the transport device can move the storage boxes to a floor storage area, where they can be stacked on top of each other.

By using a feed conveyor that need not be vertically and transversely movable, considerable space usually required by a stacker crane can be saved. The use of only one loading device saves many vulnerable transport mechanisms arranged in each shelf.

In their bottom area, the storage boxes include spaced tabs with upwardly directed lower support surfaces. In their ceiling area, the storage boxes have crossbars, which have upwardly directed upper support surfaces. The crossbars of a lower storage box when stacking the storage boxes engage in the space between the tabs of an upper storage box to form a common, almost continuous support surface at the upper storage box.

To fill the storage box with large-volume foam blocks, the storage box can be placed onto the loading device. There, conveyor elements of the loading device protrude through the space between the tabs of the storage box such that the foam blocks rest only on the conveyor elements when inserted into the storage box. A foam block is then gently introduced via the conveyor elements into the storage box. After introducing the foam block, the storage box is lifted from the loading device, and the foam block rests on the lower support surfaces.

It has proved to be advantageous for the storage boxes and the loading device to have corner fittings which engage in one another during stacking or placement by means of coupling adapters for securing purposes. Thereby, a simple fitting of the storage boxes on the loading device as well as joining storage boxes above and next to one another at the floor storage without complicated adjustment work is possible.

It has proven beneficial if at least one storage space is provided at the at least one floor storage which has elevations. Those elevations engage in the space between the tabs to provide additional support for the foam blocks. The elevations increase the bottom surface of the storage boxes formed by the lower supports, leading to a common substantially continuous support surface for the foam block. This ensures that the bottom of foam blocks arranged in the lowermost storage boxes of a floor storage are completely supported during their storage and/or curing time.

In order to adapt the device easily to different circumstances and requirements, the storage boxes may consist of at least one module. Multi-module storage boxes can be assembled by connecting members which are arranged between the modules.

For transporting the storage box, at least one module can be gripped by a spreader. If the interconnected modules are sufficiently rigid and stable, for example, only one of the modules needs to be gripped with a simple spreader, such as a container spreader. If the storage boxes are not sufficiently rigid it may be necessary to use a more elaborate container spreader which can grip each module, possibly even at multiple places.

The storage boxes may be designed to be variably adjustable at least in height. Thereby, unused storage boxes can be stacked and/or transported in a space-saving manner. In addition, soft foam blocks in the storage boxes can be compressed and thus also transported in a space-saving manner.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a schematic representation of a storage box for a device for storing and transporting large-volume foam blocks.

FIG. 2 is a side view of the storage box according to FIG. 1 on a loading device for filling large-volume foam blocks by a belt conveyor.

FIG. 3 is a front view of the arrangement according to FIG. 2.

FIG. 4 is a detailed view of the arrangement of FIG. 2.

FIG. 5 is a side view of the storage box according to FIG. 2 in its transport position.

FIG. 6 is a side view of two storage boxes according to FIG. 2 in their storage position.

FIG. 7 is a detailed view of the storage boxes according to FIG. 6.

FIG. 8 is a simplified representation of a modular device.

FIG. 9 shows the device according to FIG. 6 with a spreader for transporting the modules.

FIG. 10 is a schematic representation of a floor storage created from modules.

FIG. 11 is a front view of the loading and storage device.

FIG. 12 is a perspective view of a floor storage.

### DETAILED DESCRIPTION

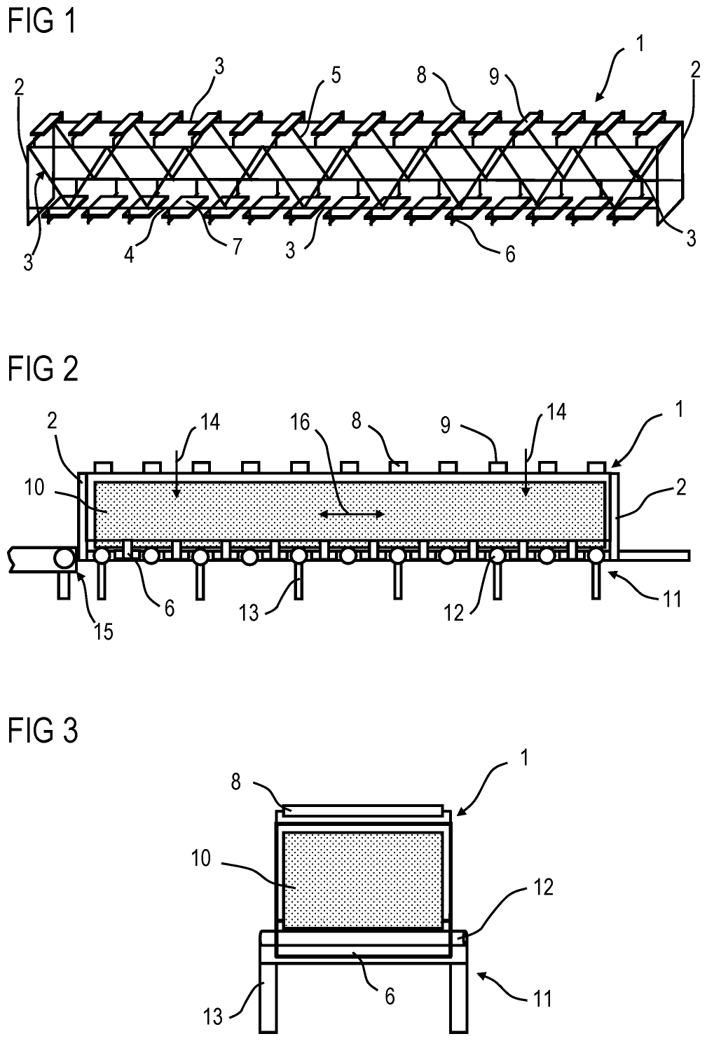

FIG. 1 shows a storage box 1 as part of a device for storing and transporting large volume foam blocks. The storage box 1 includes two front frames 2 and two side panels 3. The side panels 3 are formed as a frame, for example, a steel frame, made of two longitudinal struts 4 which for stiffening are provided with diagonal struts 5. At their bottom, the side panels 3 are connected by tabs 6, which have a lower support surface 7 for the foam blocks (not shown). The tabs 6 are arranged with a gap in between at a certain distance from each other. The side panels 3 are at the top, unlike what is shown in FIG. 1, held by preferably wide crossbars 8, the width of which matches approximately the dimensions of the distance of the tabs 6, so that the crossbars 8 can be pushed between the tabs 6. The crossbars 8 have an upper support surface 9.

FIG. 2 schematically shows a side view of the storage box 1 according to FIG. 1 for filling with large-volume foam blocks 10. The storage box 1 is arranged on a loading device 11. The loading device 11 has driven conveyor elements 12, here in form of transport rollers arranged on stands 13. The storage box 1 is placed on the loading device 11 in the direction of the arrows 14 such that the conveyor elements 12 are positioned between the support surfaces 7 of the tabs 6. The lower support surfaces 7 of the tabs 6 are positioned below the tops of the conveyor elements 12. The foam block 10 can be conveyed by a feed conveyor 15, for example, a belt conveyor in the direction of the double arrow 16 in or out of the storage box 1 by the driven conveyor elements 12. Due to the recessed arrangement of the storage box 1 in the loading device 11, the loading of the storage box 1 can take place easily and safely.

In FIG. 3, the storage box 1 according to FIG. 2 with the loading device 11 is shown in front view. It shows that the foam block 10 rests only on the conveyor elements 12 and floats above the tabs 6.

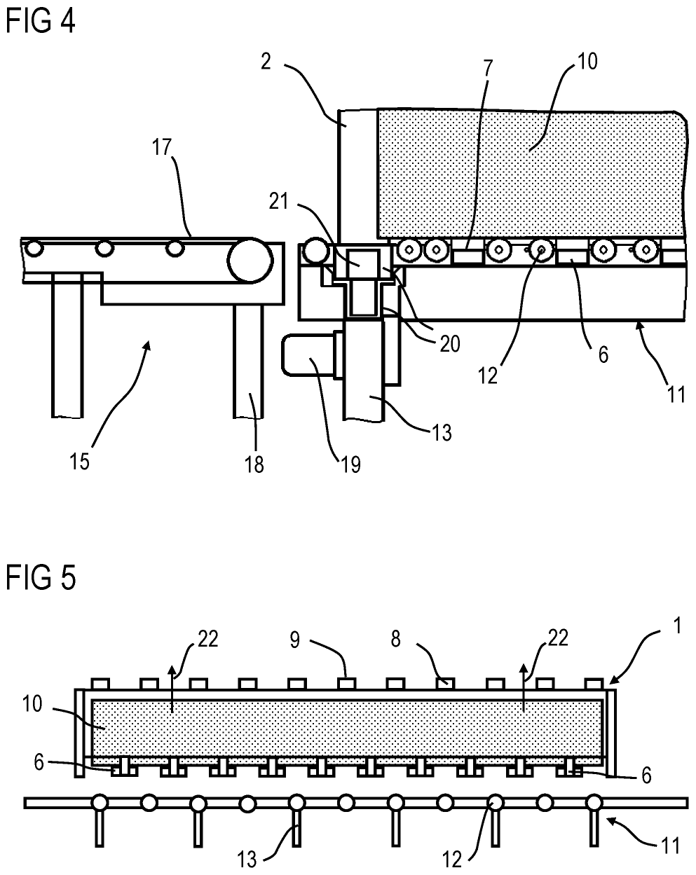

FIG. 4 shows in detail the transition from the feed conveyor 15 to the loading device 11. The feed conveyor 15 has a conveyor belt 17 which is held by a support structure 18. The conveyor elements 12 of the loading device 11 and the conveyor belt 17 are at the same height so that the foam block 10 can be freely guided into the storage box 1. The lower support surface 7 formed by the tabs 6, i.e. the bottom of the storage box 1, is placed lower than the upper edge of the conveyor elements 12 of the loading device 11. The foam block 10 rests only on the conveyor elements 12 during loading of the storage box 1 and can be moved.

A motor 19 mounted, for example, on one of the stands 13 drives the conveyor elements 12 of the loading device 11. The stand 13 has corner fittings 20 which are connected to the front frame 2 and into which coupling adapters 21 engage to secure placement of the storage box 1 on the loading device 11.

FIG. 5 shows the storage box 1 raised by the loading device 11 in the direction of the arrows 22 for transport to a floor storage 23. Since the tabs 6 lift the foam block 10 from the conveyor elements 12, the foam block 10 rests briefly during transport of the storage box 1 only on the lower support surfaces 7 of the tabs 6.

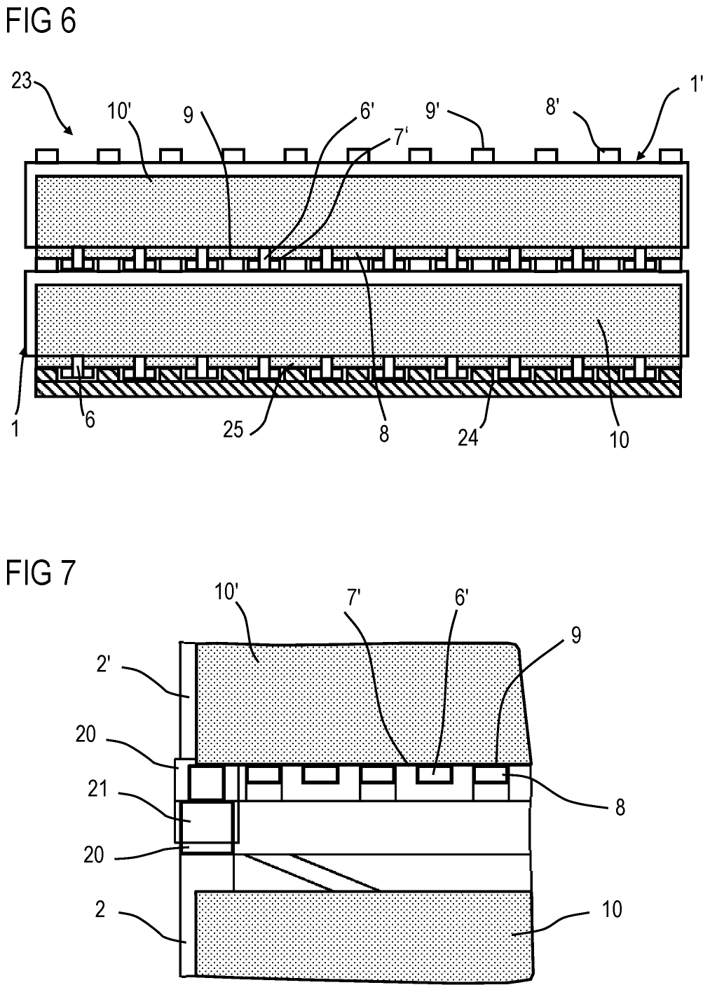

FIG. 6 now shows a floor storage 23, in which a storage box 1 is placed as a lowermost layer on a storage space 24, which is provided with supports 25 as supports for the foam block 10. These supports 25 fit exactly between the lower support surfaces 7 of the tabs 6, to jointly form an almost continuous support surface for the foam block 10. The tops of the supports 25 increase the bottom surface of the storage boxes 1 formed by the lower support surface 7.

On top of the lower storage box 1 a second, upper storage box 1′ is placed. The upper support surfaces 9 of the crossbars 8 are arranged between the lower support surfaces 7′ of the tabs 6′. Thereby a common substantially continuous support surface is formed also for the foam block 10′. Onto these two storage boxes 1 and 1′ can now be placed the storage box 1 which in FIG. 5 has been lifted from the loading device 11. In that case, the crossbars 8′ of the upper storage box 10′ fill the space between the tabs 6 of the third storage box 1. Several stacks of storage boxes 1 can be arranged side by side, thereby forming, for example, a large reaction storage with many individual shelves, in which the large-volume foam blocks 10 and 10′ can spend enough time after the foaming to cure without being deformed and can be warehoused until their further processing.

The top of the supports 25 of the storage space 24 increases the bottom surface of the lower or first storage box 1, while the top of the lower or first storage box 1 increases the bottom surface of the upper or second storage box 1′ to a nearly seamless continuous support surface. The negative and positive elevations of the storage boxes 1 through the tabs 6 and crossbars 8 during stacking form a flat support surface 7, 9 on which the foam blocks can cure.

FIG. 7 shows a detail of the arrangement according to FIG. 6 with the two stacked storage boxes 1, 1′ as well as the foam blocks 10, 10′. The two storage boxes 1, 1′ are substantially on top of one another with their front frames 2, 2′, which have the corner fittings 20, into which the coupling adapters 21 engage to secure the placement of the storage box 1′ on the storage box 1. The foam block 10′ now rests fully on the lower support surface 7′ of the tabs 6′ of the upper storage box 1′ and the upper support surface 9 of the crossbars 8 of the lower storage box 1.

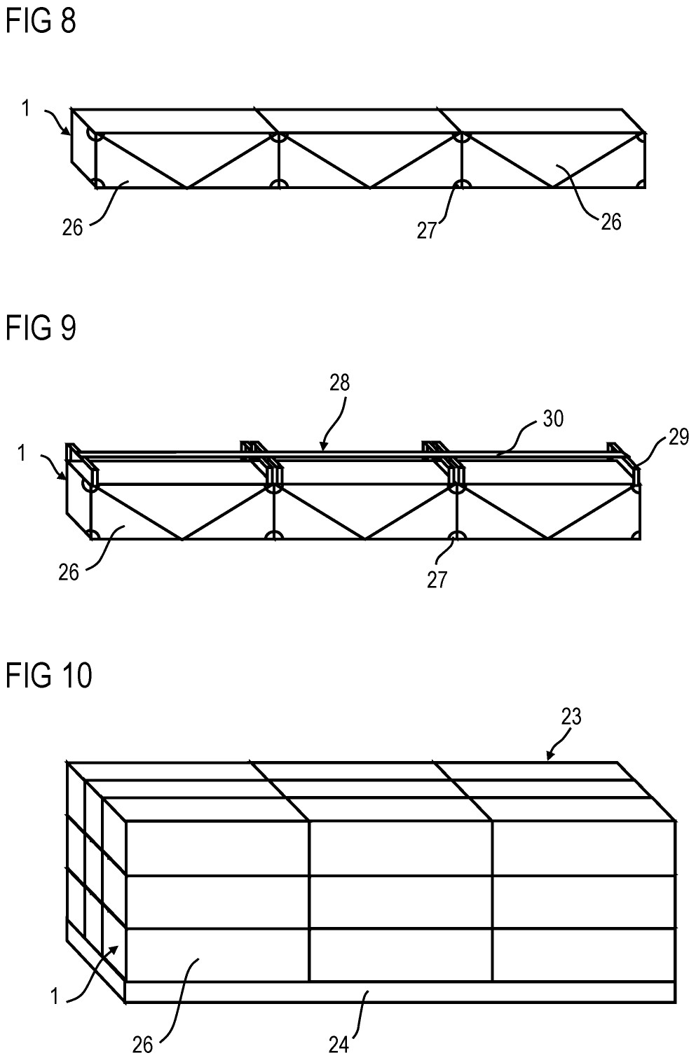

FIG. 8 schematically shows a storage box 1 composed of modules 26, which are connected to one another by connecting elements 27 at least at the corners of the modules 26. Thereby, different and also long lengths of the storage boxes 1 can be achieved in a simple manner. The connecting elements 27 may be threaded connections or a bolt-tab connection system that has proven itself in containers on container ships or a slightly modified version thereof. The modules 26 are just like the one-piece storage boxes 1 provided with tabs 6 and crossbars 8 to form a large nearly seamless support surface (7, 9) for the large-volume foam blocks 10.

FIG. 9 schematically shows a spreader 28 for transporting the storage boxes 1 made of modules 26 by a crane (not shown). The spreader includes crossbeams 29, which are hooked to the corners of the modules 26, and a longitudinal/transverse beam 30 which connect the crossbeams 29. Such transport of a container by a crane is described for example in EP 0 699 164 B1.

If the storage boxes 1 consisting of the modules 26 are sufficiently resistant to bending, for example, the two outer or else the two inner crossbeams 29 could be eliminated from the spreader 28. Of course, the storage boxes 1 can also be handled by two cranes (not shown) having spreaders with only one crossbeam 29 each.

FIG. 10 shows in simplified form a floor storage 23 which has received a plurality of storage boxes 1, each formed by a number of modules 26. Several storage boxes 1 stand next to each other as the lowest layer on the storage spaces 24 described with reference to FIG. 5 so that even the lowest storage boxes 1 provide a large and almost seamless support surface for the large-volume foam blocks 10.

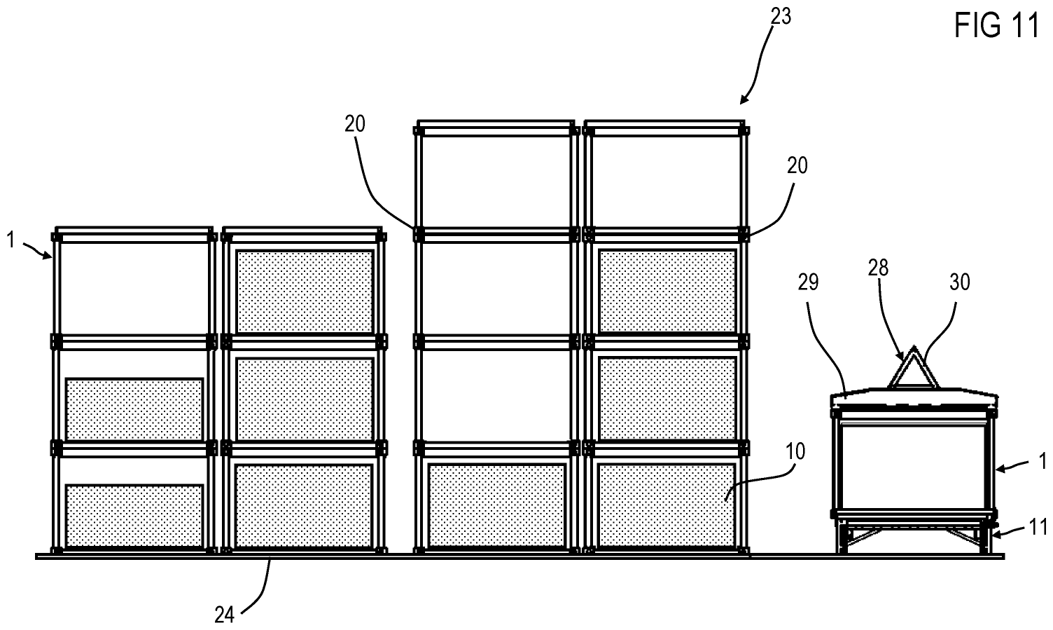

FIG. 11 shows schematically the floor storage 23 with a storage box 1 to be filled in a front view, which is placed on the loading device 11. On top of the storage box 1, the spreader 28 is arranged for transporting the storage box 1 by a crane (not shown). The spreader consists of crossbeams 29 which are hooked to the corner fittings 20 and of the longitudinal beam 30. The storage spaces 24 receive the storage boxes 1, which are optionally constructed of modules 26, such that the large-volume foam blocks 10 lie flat. The floor storage 23 consists of several stacked storage boxes 1, which are held according to the disclosure relating to FIG. 7 by the corner fittings 20 and coupling adapter 21.

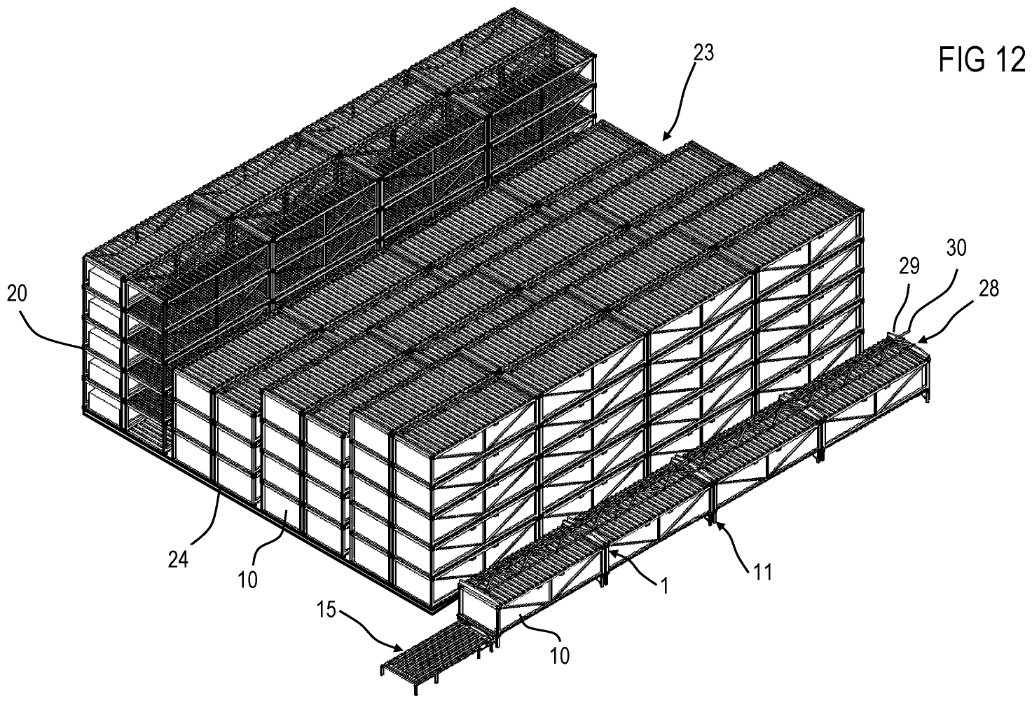

FIG. 12 shows an overview of the entire device with the feed conveyor 15, the loading device 11 with a storage box 1 situated thereon, and the bottom storage 23. A large-volume foam block 10 was introduced by the feed conveyor 15 into the storage box 1 located on the loading device 11 after the foaming process. The foam block 10 is conveyed first by the conveyor belt 17 of the feed conveyor 15 and then by the conveyor elements 12 of the loading device 11 into the storage box 1.Then the storage box 1 can be gripped by a crane (not shown), with a spreader 28 and lowered at any point on the floor storage 23. Thereby a reaction storage warehouse for curing is formed. Coupling adapters 21 engage in the corner fittings 20 for safe placement of the storage boxes 1 on top of each other.

In summary, the new storage concept is based on a simple storage box 1, which can be made by connecting several modules 26. This storage box 1 is constructed such that it can be loaded via a correspondingly designed loading device 11. It can then be transported by a commercial crane and a spreader 28 as a gripper or by a mobile lifting system, such as a truck, forklift or the like. The gripper may be based on the gripping systems for freight containers. For storage, these storage boxes 1 are simply stacked onto each other, for example, up to five stories high. The storage boxes 1 can be connected to each other like containers on container ships with a proven or slightly modified bolt-lug system, which is described for example in EP 0 699 164 B1.

The storage boxes 1 have tabs 6 with a defined pronounced geometry which recede below the conveying elements 12 while loading the foam block 10 on the loading device 11. At the top of the storage boxes 1, crossbars 8 are arranged at an offset so that after stacking of the storage boxes 1 a nearly continuous support surface for the large volume foam blocks 10 is created in the block or honeycomb storage system 23. This double support during storage is particularly beneficial in combination with soft-elastic and in particular fresh, not yet cured foam blocks 10 to ensure the dimensional stability of the foam blocks 10. Thus, the device ensures optimal handling of the fresh blocks without physical impairment, in particular for demanding foams.

For reasons of saving space during storage and transport unused storage boxes 1, and possibly to compress the foam blocks for further transport, the storage boxes 1 may be formed to be variably adjustable at least in height. For this purpose, sliding or folding mechanisms can be used.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### LIST OF REFERENCE NUMBERS

1 storage box
2 front frame
3 side panels
4 longitudinal struts
5 diagonal struts
6 tabs
7 lower support surfaces
8 crossbars
9 upper support surfaces
10 foam block
11 loader
12 conveyor elements
13 stand
14 arrows
15 feed conveyor
16 double arrow
17 conveyor belt
18 support structure
19 motor
20 corner fittings
21 coupling adapter
22 arrows
23 floor storage
24 storage space
25 supports
26 modules
27 connecting means
28 spreader
29 crossbeam
30 longitudinal beam

What is claimed is:

1. A device for storing and transporting large-volume foam blocks, comprising:
a mobile, stackable storage box for receiving a foam block at a loading position; and
a transport device for transporting the storage box from the loading position to a floor storage.

2. The device according to claim 1, further comprising
a feed conveyor; and
a loading device arranged at the loading position,
wherein, during use, the storage box is placed onto the loading device,
the foam block is loaded by the feed conveyor and the loading device into the storage box, and
the storage box, after the foam block has been loaded therein, is transported, by the transport device, to the floor storage and there stacked onto other storage boxes.

3. The device according to claim 2,
wherein the storage box includes tabs arranged at a distance from one another at its bottom, the tabs having upwardly directed lower support surfaces,
wherein the storage box includes crossbars at its ceiling, the crossbars having upwardly directed upper support surfaces, and
wherein when stacking an upper storage box onto a lower storage box the crossbars of the lower storage box are arranged in spaces between the tabs of an upper box such that the lower support surfaces of the upper storage box and the upper support surfaces of the lower storage box jointly form a common support surface.

4. The device according to claim 3,
wherein the loading device comprises a plurality of conveyor elements, and
wherein when the storage box is placed onto the loading device the conveyor elements protrude through the spaces between the tabs so far that the foam block while being inserted into the storage box rest only on the conveyor elements.

5. The device according to claim 3,
wherein at least one storage space is provided at the floor storage, which has elevations that engage as supports for the foam block in the spaces between the tabs such that the supports increases a bottom surface of the storage box formed by the lower supports such that a common support surface is formed for the foam block.

6. The device according to claim 3,
wherein the storage box and the loading device have corner fittings which engage in one another during stacking or placement and are secured by coupling adapters.

7. The device according to claim 1,
wherein the storage box comprises at least one module, and
wherein a plurality of modules can be joined together by connecting elements arranged between the modules to form the storage box.

8. The device according to claim 7,
wherein at least one module can be gripped by a spreader for transporting the storage box.

9. The device according to claim 7,
wherein the storage box is variably adjustable at least in its height.
